(19) United States
(12) Patent Application Publication
(10) Pub. No.: US 2016/0117702 A1
(43) Pub. Date: Apr. 28, 2016

(54) TREND-BASED CLUSTERS OF TIME-DEPENDENT DATA

(71) Applicant: Vedavyas Chigurupati, Bodhan (IN)

(72) Inventor: Vedavyas Chigurupati, Bodhan (IN)

(21) Appl. No.: 14/523,475

(22) Filed: Oct. 24, 2014

(51) Int. Cl. G06Q 30/02; G06F 17/30

(52) U.S. Cl. CPC G06Q 30/0204; G06F 17/30342

(57) ABSTRACT

Systems and methods for clustering or classification of time-dependent data are described herein. The systems and methods, which are computer-implemented, involve trend-based time series analysis for clustering or classification of time-dependent data. In the context of time-dependent consumer transaction data in retail or other commercial markets, the systems and methods are configured to cluster or group consumers by common characteristics or features to enable targeted consumer engagement or incentives.

### BACKGROUND

A time series is a sequence of data points, measured typically at successive points in time, which may, for example, be spaced at uniform time intervals. For convenience in description herein, time series data may be interchangeably referred to herein as time-dependent data.

In several applied science and engineering fields (e.g., signal processing, pattern recognition, econometrics, weather forecasting, seismology, electroencephalography, control engineering, astronomy, communications engineering, etc.), which involve temporal measurements, time series data or time-dependent data can be collected and analyzed to develop predictive models for forecasting events. In the context of signal processing, control engineering and communication engineering time series analysis can be utilized for signal detection and estimation. In the context of data mining, pattern recognition and machine learning, time series analysis can be used for clustering, classification, query by content, anomaly detection as well as forecasting.

Consideration is being given to systems and methods for clustering or classification of time series data or time-dependent data.

### SUMMARY

In a general aspect, a method for providing services to consumers includes receiving, by a computer, data records from a computer database. Each individual data record is consumer-indexed and includes time-dependent consumer transactions data associated with an individual consumer over a period of time.

In a further aspect, the method involves partitioning the data records in to a number of consumer clusters by designating a respective one of the data records as a cluster center for each of the number of consumer clusters, determining a similarity between each of the remaining data records and each of the consumer cluster centers, and assigning each of the remaining data records to a respective consumer cluster having the most similar cluster center, and targeting services to the consumers, cluster-by-cluster, based on the consumer cluster to which the consumers belong.

The details of one or more implementations are set forth in the accompanying drawings and the description below. Further features of the disclosed subject matter, its nature and various advantages will be more apparent from the accompanying drawings the following detailed description, and the claims.

### BRIEF DESCRIPTION OF THE DRAWINGS

FIG. 1 is an example graph illustrating sets of example retail transactions data records of consumers that may be processed by the clustering solutions described herein.

FIG. 2 is an example graph illustrating other sets of example retail transactions data records of consumers that may be processed by the clustering solutions described herein.

FIG. 3 is a block diagram illustration of an example system for implementing trend-based clustering solutions for analysis of time-series data, in accordance with the principles of the disclosure herein.

FIG. 4 is an example plot of a dataset before clustering. Each line in the plot indicates data curve for a consumer, in accordance with the principles of the disclosure herein.

FIG. 5 is an example plot the clustered dataset after processing by a trend-based clustering solution configured to select four cluster centers, in accordance with the principles of the disclosure herein.

FIG. 6 is an example plot the clustered dataset after processing by a trend-based clustering solution configured to select three cluster centers, in accordance with the principles of the disclosure herein.

FIG. 7 is an example plot the clustered dataset after processing by a trend-based clustering solution configured to select two cluster centers, in accordance with the principles of the disclosure herein.

FIG. 8 illustrates an example method for providing differentiated services (e.g., products, goods, incentives, marketing materials, customized services, etc.) to entities (e.g., consumers), in accordance with the principles of the disclosure herein.

FIG. 9 illustrates another example method for providing differentiated services (e.g., products, goods, incentives, marketing materials, customized services, etc.) to entities (e.g., consumers), in accordance with the principles of the disclosure herein.

### DETAILED DESCRIPTION

Systems and methods for clustering or classification of time-dependent data are described herein. The systems and methods, which are computer-implemented, may involve trend-based time series analysis for clustering or classification of time-dependent data, in accordance with the principles for the disclosure herein.

For convenience in description, the systems and methods (collectively “trend-based clustering solutions”) are described herein in the context of time series analysis of time-dependent consumer transaction data for consumer engagement in retail or other commercial markets. The consumer transaction data may, for example, include temporal data related to purchases of products by consumers in a network of point-of-sales (e.g., retail stores operated by a retailer or other business). The time-dependent consumer transaction data that is the subject of the time series analysis described herein may include multidimensional data records, which, for example, include values for multiple characteristics of the products and/or the consumers involved in the consumer transactions. The multiple characteristics of a product included in a multidimensional data record may, for example, characteristics such as product identifiers, name, brand, manufacturing origin, price, discounts, etc. The multiple characteristics of a consumer included in a multidimensional data record may, for example, demographic characteristics such as age group, location of transaction, residence, etc.

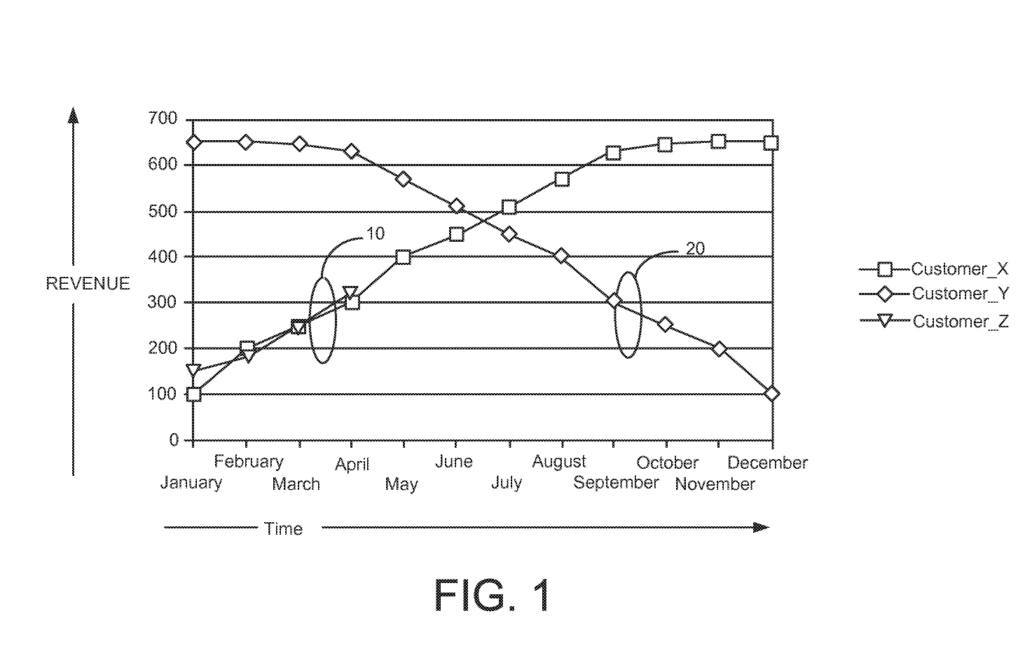

It will, however, be understood that the trend-based clustering solutions described (e.g., with reference to FIGS. 1-8) herein are not limited to analysis of the example consumer transaction data or consumer engagement purpose, but may be may be utilized to analyze time series data in any field (e.g., signal processing, pattern recognition, econometrics, weather forecasting, seismology, electroencephalography, control engineering, astronomy, communications engineering, etc.) and for any purpose (e.g., stock market analysis, weather prediction, earthquake predictions, etc.). In the example of time series analysis of consumer transactions data (e.g., retail transactions involving purchases of products), a retailer may, for example, gather product, consumer, and temporal transactions data involving large numbers of consumers and consumer products, in a relational database. In the relational database, product information, which may be uniquely identified (e.g., by type, brand or manufacturer) may grouped into generic product clusters. Consumers may be similarly grouped into consumer clusters based on common consumer demographics and other characteristics such as purchasing habits. Consumer retail transactions may be analyzed, using the clustering solution described herein, in terms of product and/or consumer clusters to determine relationships between the consumers and the products. The retailer may query the database using selected criteria (e.g., to identify specific consumer buying habits, needs, demographics, etc.) and use the query results to make business and marketing decisions (e.g., targeting specific consumers with marketing and other promotional literature, increasing or maintaining product exposure in particular geographies or for particular consumer groups or clusters, while discontinuing product sales in other geographies or to other consumer groups or clusters, etc.).

TABLE I (and FIG. 1) shows, for purposes of illustration only, example retail consumer transaction data records (for Consumers X, Y and Z) that may be processed by the clustering solutions described herein.

TABLE I

| | | |
|---|---|---|
| Consumer: X | Consumer: Y | Consumer: Z |
| Year: 2013 | Year: 2013 | Year: 2014 |

| Month | $$ | Month | $$ | Month | $$ |
|---|---|---|---|---|---|
| January | 100 | January | 650 | January | 350 |
| February | 200 | February | 650 | February | 180 |
| March | 250 | March | 645 | March | 250 |
| April | 300 | April | 630 | April | 320 |
| May | 400 | May | 570 | May | |
| June | 450 | June | 510 | June | |
| July | 510 | July | 450 | July | |
| August | 570 | August | 400 | August | |
| September | 630 | September | 300 | September | |
| October | 645 | October | 250 | October | |
| November | 650 | November | 200 | November | |
| December | 650 | December | 100 | December | |
| TOTAL | 5355 | TOTAL | 5355 | TOTAL | 900 |

As shown in TABLE I, the example retail consumer transaction data records for Consumers X and Y may, for example, include monthly aggregate dollar amounts of purchases made from the retail stores by the consumer in each month of the year 2013. The transaction data for Consumer Z may, for example, include monthly aggregate dollar amounts of purchases made from the retail store by the consumer in the first four months (January-April) of the year 2014. For the year 2013, each of Consumer X and Y has the same total amount of purchases (e.g., $5355). For the year 2014, Consumer Z may have a total amount of purchases of only $900. FIG. 1 shows the retail consumer transaction data records for Consumers X, Y and Z as data curves in graph form. For convenience in description, the terms “data records” and “data curves” may be used interchangeably hereinafter. Further, clustering or grouping of individual data records or data curves will be understood to be the same as clustering or grouping the entities (e.g., consumers) associated with the individual data records or data curves.

As may be visually discerned from the data curves in FIG. 1, even though consumers X and Y have the same total amount of purchases in the year 2013, Consumer X may have an increasing trend of monthly purchase amounts throughout the year 2013, while Consumer Y may have a decreasing trend of monthly purchase amounts throughout the year 2013. Further, while Consumer Z may have a lower total purchase amount (through the first four months of the year 2014) than the total amount of purchases in the year 2013 by either Consumer X or Consumer Y, the monthly purchase amounts for Consumer Z in 2014 may be increasing at about the same rate as the monthly purchase amounts for Consumer X in a comparable time segment (e.g., January to April) of the year 2013.

Existing clustering techniques for clustering time series data that are random samples of observations include techniques such as k-means, hierarchical clustering, density-based clustering or subspace clustering. These clustering techniques may be used, to find clustering structures in time-dependent data. However, these clustering techniques (e.g., k-means technique) when applied to cluster the transaction data records in TABLE 1 based, for example, on aggregate or total amounts of purchases, may result in misleading forecasts of consumer behavior. For example, the k-means technique may place consumers X and Y in a same cluster (because they have the same aggregate annual purchase amounts) and consumer Z in a different cluster because consumer Z has a lower annual purchase amount to date). A retailer making business or marketing decisions based on such clustering may be mislead, for example, into believing that Consumers X and Y may have similar purchasing behavior in 2014 even though the data curve trends suggest that Consumer X's purchases that were increasing throughout 2013 may be expected to keep increasing in 2014, while Consumer Y's purchases that were decreasing throughout 2013 may be expected to keep decreasing in 2014. Further, by placing consumer Z in a different cluster than consumer X, the results of the k-means technique (based on aggregate annual purchase amounts) may not properly inform the retailer that consumer Z's purchasing behavior even though observed for a limited time period (e.g., January to April) is similar to that of consumer X in that both show a comparable rate of increase.

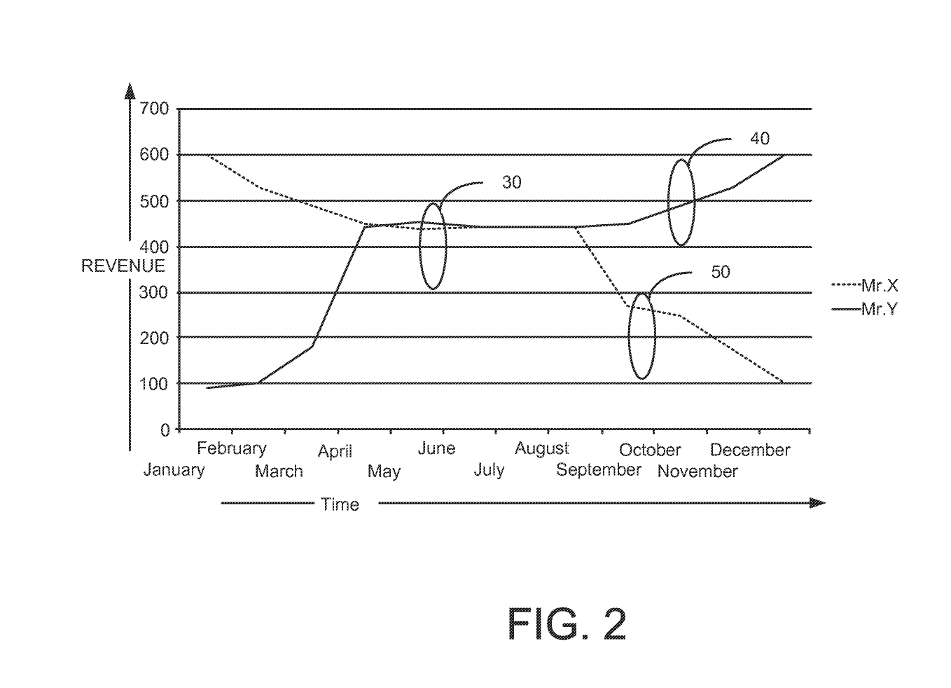

TABLE II (and FIG. 2) shows, for purposes of illustration only, another set of example retail consumer transaction data records (e.g., for Consumers A and B) that may be processed by the clustering solutions described herein.

TABLE II

| | |
|---|---|
| Consumer: A | Consumer: B |
| Year: 2013 | Year: 2013 |

| Month | $$ | Month | $$ |
|---|---|---|---|
| January | 100 | January | 650 |
| February | 200 | February | 650 |
| March | 250 | March | 645 |
| April | 300 | April | 630 |
| May | 400 | May | 570 |
| June | 450 | June | 510 |
| July | 510 | July | 450 |
| August | 570 | August | 400 |
| September | 630 | September | 300 |
| October | 645 | October | 250 |
| November | 650 | November | 200 |
| December | 650 | December | 100 |
| TOTAL | 5355 | TOTAL | 5355 |

As shown in TABLE II, the time series transaction data records for Consumers A and B may, for example, include monthly aggregate dollar amounts of purchases made by Consumers A and B from the retail stores in each month of the year 2013. FIG. 2 shows the time series transaction data records for Consumers A and B as data curves in graph form. As may be visually discerned from the data curves in FIG. 2, even though consumers A and B have about the same total amount of purchases (of $5355) in the year 2013, Consumers A and B may have different seasonal behaviors for purchases throughout the year. For example, both consumer A and B may have comparable purchase amounts in the middle months (e.g. April to September) of the year. However, purchases by consumers A and B may respectively increase and decrease in the months (e.g., October to December) toward the end of the year. Using the k-means technique (or other existing clustering techniques such as hierarchical clustering, density-based clustering or subspace clustering) may place Consumers A and B in a same cluster (e.g., because they have the same aggregate annual purchase amounts). A retailer making business or marketing decisions based on such clustering may be not properly informed by such clustering of the seasonal variations in the purchasing behaviors of consumers A and B, and as such may miss opportunities to make season-based targeted marketing efforts to increase sale of the retailer's products. The retailer may, for example, miss an opportunity to differentially target marketing efforts toward Consumers A and B to increase the latter's purchases in the end-of-year season (e.g., October to December).

As shown in example TABLES 1 and II (and corresponding FIGS. 1 and 2) example retail consumer transaction data records may have three significant characteristics or features-a Trend-in-time feature, a Rate-of-change feature and a Seasonality feature. The trend feature may, for example, characterize whether a time-dependent data curve (representing the retail consumer transaction data record) is increasing or decreasing over a time period (e.g., January to December, year 2013) of the retail consumer transaction data record. The Rate feature may, for example, characterize a slope or how fast the time-dependent data curve is changing over the time period. The Seasonality feature may, for example, characterize the behavior (e.g., trend and/or rate) of the time-dependent data curve in a selected season or time segment (e.g., October to December 2013) of the retail consumer transaction data record.

In contrast to the existing clustering techniques (e.g., k-means, hierarchical clustering, density-based clustering or subspace clustering) that are used for processing random observations data, the trend-based clustering solutions described herein for clustering time-dependent data (e.g., retail consumer transaction data records) may include clustering processes that take into account the Trend, Rate and Seasonality features of the retail consumer transaction data records), in accordance with the principles of the present disclosure.

When applied for example, to the data curves shown in FIG. 1, the trend-based clustering solutions described herein may place the data curve for consumer X (having an increasing trend) and the data curve for consumer Y (having a decreasing trend) in a different clusters (e.g., cluster 10 and cluster 20, respectively) based on the differing Trend features of the two data curves. Further, the trend-based clustering solutions described herein may place the data curve for consumer Z in the same cluster (i.e. cluster 10) as the data curve for consumer X based on the similar or comparable Trend and Rate features of the two data curves over the season or time interval January to April.

When applied for example, to the data curves shown in FIG. 2, the trend-based clustering solutions described herein may be used cluster the data curves differently taking into account the Seasonality features of the data curves. For example, for the season or time segment April to August, the data curves for Consumers A and B may be placed in a common cluster (e.g., cluster 30) because of the similar Trend features of the two data curves in the season or time segment. However, for the season or time segment September to December, the data curves for Consumers A and B may be placed in different clusters (e.g., cluster 40 and cluster 50, respectively) because of the different Trend features (e.g., increasing and decreasing, respectively) of the two data curves for the season or time segment September to December.

The examples described above with reference to TABLES I AND II (and corresponding FIGS. 1 and 2) illustrate clustering using only a few (e.g., 2 or 3) consumer transaction data records only for purposes of illustration. It will be understood that trend-based clustering solutions described herein, which are computer-implemented, are applicable to clustering any number of data records in various scenarios (e.g., in retailing industry scenarios, which may involve thousands or millions of retail consumer transaction data records).

The trend-based clustering solutions describe herein may involve dynamic programming to reduce computational complexity, for example, when processing large numbers of retail consumer transaction data records (which may number in the thousands or millions in some retail scenarios (e.g., grocery store transactions)) or when the retail consumer transaction data records are multi-dimensional (i.e. have values for multiple variables).

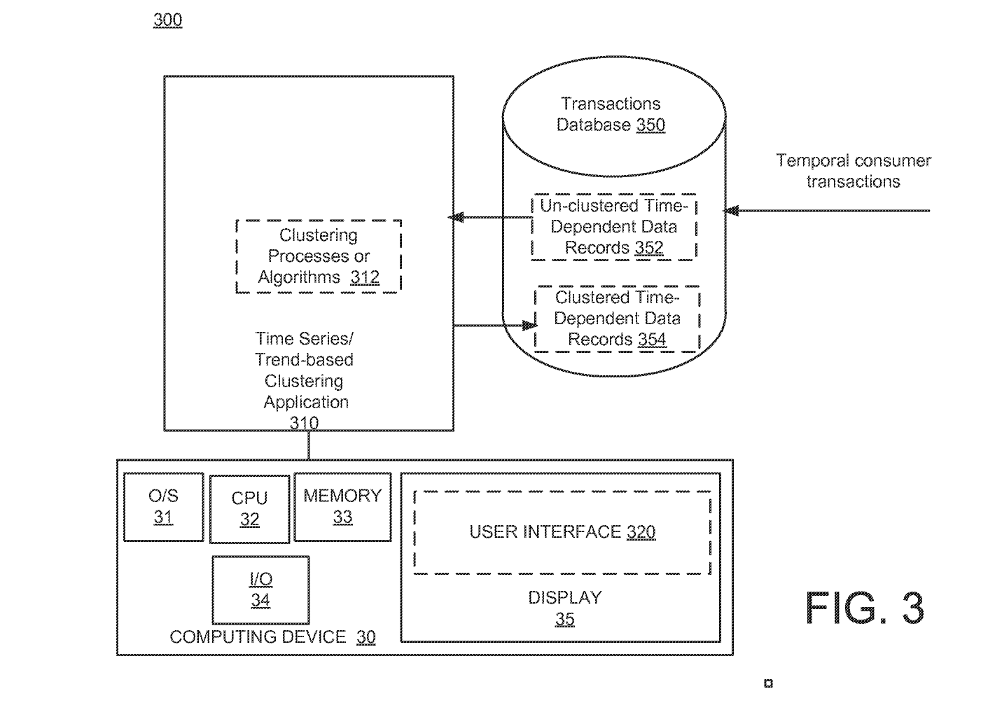

FIG. 3 shows an example system 300 for implementing the trend-based clustering solutions for analysis of time-dependent or time-series data records, in accordance with the principles of the present disclosure. The time-dependent data records may, for example, be temporal consumer transaction data related to one or more consumer activities or events (e.g., purchases of products from retail stores of a retailer or business, credit card transactions, store visits, etc.). Raw consumer transaction data, which may be received live or at periodic time intervals from the retail stores by system 300, may be accumulated or prepared as data records (e.g., as consumer-indexed table entries or data strings) in a database 350. FIG. 3 shows the prepared data records assembled, for example, as un-clustered time-dependent transactions data records 352.

System 300 may further include a trend-based clustering application 310, which may be structured to determine or characterize trends and rates in the consumer transactions data (e.g., un-clustered time-dependent transactions data 352). Trend-based clustering application 310 may be configured to process un-clustered transactions data 352 using data metrics (e.g., Trend, Rate, etc.) to partition the time-dependent data into groups or clusters of data records with similar data metrics (e.g., trend and/or rate metrics). Un-clustered transactions data 352 may be partitioned or grouped in clusters using the data metrics over an entire time period (e.g., a year) over which the data is applicable or partitioned or grouped in clusters using the data metrics over only limited time segments or seasons (e.g., January to March, holiday season, etc.) of the entire time period or range of the data.

The clustered data output (e.g., clustered transactions data 352) of trend-based clustering application 310 may stored in database 350 or otherwise made available (e.g., on UI 320) to users (e.g., the retailer) for further processing and use (e.g., to identify consumer clusters or groups associated with the data record clusters and to make business and marketing decisions directed to consumer clusters or groups). The retailer may make the business and marketing decisions directed to specific consumer clusters or groups based, for example on characteristics or features (e.g. trends, rates, seasonality, etc.) of the data record clusters.

In system 300, trend-based clustering application 310 and other system components (e.g., database 350) may be hosted on one or more standalone or networked physical or virtual computing machines. FIG. 1 shows, for example, trend-based clustering application 310 hosted on a computing device 30 (e.g., a desktop computer, a mainframe computer, a server, a personal computer, a mobile computing device, a laptop, a tablet, or a smart phone), which may be available to a user. Computing device 30, which includes an O/S 31, a CPU 32, a memory 33, and I/O 34, may further include or be coupled to a display 35 (including, for example, a user interface 320). Clustered time series data (e.g., clustered transactions data 352) generated by pricing recommendation application 310 may be presented to the user, for example, on user interface 320.

Moreover, although computer 30 is illustrated in the example of FIG. 3 as a single computer, it may be understood that computer 30 may represent two or more computers in communication with one another. Therefore, it will also be appreciated that any two or more components of system 300 may similarly be executed using some or all of the two or more computing devices in communication with one another. Conversely, it also may be appreciated that various components illustrated as being external to computer 30 may actually be implemented therewith.

Trend-based clustering application 310 may be linked, for example, via Internet or intranet connections, to database 350 and other data sources (not shown) having information on the retailer's consumers and/or products. Further, pricing recommendation application 310 may be linked to data sources on the web (e.g., worldwide and/or enterprise webs) and/or or other computer systems of the organization (e.g., e-mail systems, human resource systems, material systems, operations, etc.) that may have information relevant to the implementation or use of the results of the trend-based data clustering solutions.

For time-dependent data clustering, a distance or similarity criteria may be selected for the Trend, Rate and Seasonality features of retail consumer transaction data records. These similarity criteria may be used to identify or find clustering structure in the retail consumer transaction data records. For this purpose trend-based clustering application 310 may, for example, include trend-based data clustering process or algorithm 312 configured to cluster time-dependent data curves (e.g. un-clustered transactions data 352) into different clusters based on a distance or similarity of one or more of the Trend, Rate or Seasonality features of the time-dependent data curves.

The following terminology or definitions may be relevant to the description of an example trend-based data clustering process or algorithm 312 herein.
Time-Dependent: Successive values in the data record represent consecutive measurements taken at equally/randomly spaced time intervals.
Trend-Component: A general systematic, linear or (most often) nonlinear component that changes over time and does not repeat or at least does not repeat within the time range captured by the time-dependent data curves or data records
Rate-Component: A Relative measure between two Data-curves, this represents the rate of increase or decrease in different dimensions with respect to time dimension
Seasonality-Component: Formally similar nature or shape (e.g., a plateau followed by a period of exponential growth) in the data record, which can repeat itself in systematic “seasonal” intervals over time.
BindingLength: Maximum distance between data points of two time-dependent data curves minimized over all possible pairings of the data points.
Similarity: Average Binding Length.
Epoch: Indicates one feeding the data to algorithm (i.e. one iteration of the data processing)

Un-clustered transactions data 352 (at least for purposes of processing by algorithm 312) may be described as activities/variables (n) of the consumer in a (n+1)-dimensional vector space (the n+1^{th} dimension being time). Each of the n activities/variables plotted on a separate axis/dimension against a time axis (i.e. the n+1th dimension) may represent a-dependent data curve (as shown for example in FIGS. 1 and 2). Thus, un-clustered transactions data 352 may be represented by n time-dependent data curves. In example implementations of system 300, algorithm 312 may be configured to cluster these multi-dimensional time-dependent data curves representing un-clustered transactions data 352 in (n+1)-dimensional vector space using, for example, trend-in-time, rate-of-change, and/or seasonality similarity metrics.

Un-clustered transactions data 352 may be grouped, partitioned or clustered in a user-selected or computer-selected number (M) of clusters. To initiate the clustering process a corresponding number M of data curves in un-clustered transactions data 352 may be selected (e.g., randomly) as cluster seeds or centers. Other data curves (e.g., a remaining data curve) in un-clustered transactions data 352 may be clustered one-by-one with a respective one of the M cluster centers depending on the similarity of features (e.g., trend-in-time, rate-of-change, seasonality, etc.) between the remaining data curve and the respective one of the M cluster center.

In an example implementation of system 300 to achieve the clustering of multi-dimensional time-dependent data curves, trend-based data clustering algorithm 312 may involve computing a similarity measure ‘AverageBindingLength’ between two time-dependent data curves, where the ‘BindingLength’ between the two time-dependent data curves may be defined as the ‘maximum distance between the data points in the two time-dependent data curves minimized over all possible pairing of the data points’. The following methodology may be used, for example, to compute the similarity measure AverageBindingLength of two time-dependent data curves.

### Methodology for Computing Similarity Measure ‘AverageBindingLength’

Consider, for example, two time-dependent data curves ‘P’ and ‘Q’ having a number of points n and m, respectively. Let {p1, p2, p3, p4, p5, p6 . . . , pi, . . . , pn} be points of curve ‘P’, and {q1, q2, q3, q4, . . . , qj . . . , qm} be points of curve ‘Q’. The number of all possible pairing of the points in data curves ‘P’ and ‘Q’ may be equal to nm. A possible pairing of points in a Scenario 1 “Sk” may be defined as
[(p1,q1), (p1,q2), . . . , (p1,qa), (p2,qa+1), . . . (p2,qb), . . . , (p3,qb+1), . . . , (p3,qc), . . . , (Pi,qi), . . . , (pi,qm)].

For each of the “nm” possible pairing scenarios Sk, compute a BindingDistance (BDk) as follows

BindingDistance(BDk)=MAX[Distance(p1,q1),Distance(p1,q2), . . . ,Distance(p1,q a),Distance(p2,qa+1), . . . Distance(p2,qb), . . . ,Distance(p3,qb+1), . . . ,Distance(p3,qc), . . . ,Distance(pi,qj), . . . ,Distance(pi,qm)].

After computing the BindingDistance (BDk) for each of the “nm” possible pairing scenarios Sk, compute the BindingLength between the two time-dependent data curves ‘P’ and ‘Q’ as follows

BindingLength(BL)=MIN(BD1,BD2,BD3, . . . BDk, . . . BDnm).

Further, let Pc1, Pc2, Pc3, . . . , Pci, . . . , Pcn represent the curve ‘P’ when number of data points in the curve is 1, 2, 3, . . . i, . . . n. Similarly, let Qc1, Qc2, Qc3, . . . Qcj, . . . , Qcm represent the curve ‘Q’ when number of data points in the curve is 1, 2, 3 . . . , j, . . . m. Then, compute the AverageBindingLength (ABL) between curves ‘P’ and ‘Q’ as follows

AverageBindingLenght(ABL)=AVERAGE(BindingLength(Pc1,Qc1), . . . ,(BindingLength(Pck,Qck), . . . ,BindingLength(Pc min(m,n),Qc min(m,n)).

### Methodology for Computing Cluster Centers

Trend-based data clustering algorithm 312 may be configured to cluster the multi-dimensional time-dependent data curves representing un-clustered transactions data 352 (“dataset D”) by using iterative process cycles (or epochs) to calculate cluster centers and group the data curves about the cluster centers. Predefined stopping criteria may be used to limit the number of iterations.

To start the first iterative process cycle or epoch, trend-based data clustering algorithm 312 may be configured to randomly select or designate a number M of the data curves in the dataset D as cluster centers and then compute the AverageBindingLength (ABL) for every data curve in the dataset relative to each of the selected M centers. Trend-based data clustering algorithm 312 may assign a data curve to the selected cluster center which yields a least or minimum ABL for the data curve and the selected cluster center.

For the next iterative process cycle or epoch, trend-based data clustering algorithm 312 may be configured to recalculate each selected or designated cluster center using the using the data curves that are assigned to that cluster center in the previous epoch. The following methodology may be used, for example, to recalculating a selected cluster center.

### Example Methodology for Recalculating a Selected Cluster Center

Let {d1, d2, d3, . . . , di, . . . , dn} be the data curves in the dataset D, and let {c1, c2, c3, . . . cj, . . . , cm} be the number of cluster centers, where m is equal to number of clusters (M) into which the dataset D has to be clustered or segmented into. After the first epoch, consider a data curve di that may have been assigned to cluster center cj because the ABL between di and cj is less than the ABL between di and all other cluster centers. Let Sk be the pairing scenario which yielded the BindingLength (BL) with di and cj at full length, and designate that Sk as CANDIDATE (j,i).

If “mm” data curves in dataset D were assigned to cluster center cj in the first epoch, it may be expected that there will be “mm” such CANDIDATE (j,i), i=1 to mm.

A point wise average of the mm CANDIDATE (j,i), i=1 to mm, may represent a new or recalculated cluster center cj.

In an example implementation of system 300, trend-based data clustering algorithm 312 may be configured to recalculate a new selected cluster center cj as

cj=AVERAGE(CANDIDATE(j,1), . . . ,CANDIDATE(j,m)).

Each iterative process cycle or epoch of algorithm 312 may involve calculating new cluster centers and assigning the data curves in the dataset D to the new cluster center as described above.

Algorithm 312 may use predefined stopping criteria to exit the iterative process cycles and output the M data curve clusters computed in the last epoch. In an example implementation of system 300, the stopping criteria may be a user-set or pre-defined maximum number of cycles or epochs. Alternative stopping criteria to exit the iterative process cycles may involve self-limiting procedures. In an example self-limiting procedure, a new epoch may not be initiated when fewer than a pre-defined number of curves in dataset D are reassigned to a different cluster center in the current epoch. An alternate self-limiting procedure may involve not starting a new epoch when the ABL between the cluster centers in the previous and current epoch is less than a certain pre-defined distance.

Algorithm 312 may be implemented in system 300 using any programming technique or code. As noted earlier, dynamic programming techniques may be used to reduce computational complexity. With dynamic programming techniques, a run time complexity of the algorithm may be expected to of a polynomial order. The following is an example pseudo-code representation of an example implementation of algorithm 312.

### Example Algorithm Pseudo Code

```
    Function dist(p,q): {Euclidian distance between p,q}
    input :multidimensional point,multidimensional point return : real
    end
    Function similarityMeasure(P,Q): {real,multidimensional polygonal curve};
    input : multidimensional polygonal curves
    P=(p1,p2,p3,...,qm),Q=(q1,q2,q3,...,qn) variables: dp : array[1...m,1...n]
    R : (r1,r2,r3,....,rm) // initially null ABL : 0 // initially zero
    dp(1,1)=dist(p1,q1)
    for i=1 to m do dp(i,0)=max(dp(i−1,0),dist(i,0))
    for j=1 to n do dp(0,j)=max(dp(0,j−1),dist(0,j)) for i=2 to m do
    pre=dp(i,1) candidate=1; for j=2 to n do
dp(i,j)=max(min(dp(i−1,j−1),dp(i,j−1),dp(i−1,j)),dist(i,j)
    if(dp(i,j)<pre) candidate=j R(i)=Q(candidate)
    for i=0 to min(m,n)
    ABL +=dp(i,i)
return(RES,R)
end
Function adjustCenters(C,N,R,ep): {list of multidimensional polygonal curve} input :
list of multidimensional polygonal curve C={c1,c2,c3,...,ck},
list of multidimensional polygonal curve N={n1,n2,n3,...,nt},
array of integers R={r1,r2,r3,...,rt} // ri is the center assigned to ith curve real ep // if less
than e curves change centers then classification stops there
    return : list of multidimensional polygonal curve M={m1,m2,m3,...,mt} if(no.of
    curves changed centers < e)
    return C,
    stop algorithm
    if(any center has 0 curves assigned) remove that center from centers list,
assign a curve, which is assigned to center with maximum no. of curves assigned
    else
    mi=average of all nj where rj=i
    return(M)
    end
    Function classify(P,ep,C,e): {list of multidimensional polygonal curve} input : list
    of multidimensional polygonal curve P={p1,p2,p3,...,pt}
    real ep //maximum number of epochs
    list of multidimensional polygonal C ={c1,c2,c3,...,ck)//initial centers e // accepted
    error or epsilon
    return : list of multidimensional polygonal curve
    R={r1,r2,r3,...,rk} // k centers to which other curves are associated variables :
    q={real,multidimensional polygonal curve}
  _q={real,multidimensional polygonal curve}
l={list of multidimensional polygonal curve} B={list of multidimensional polygonal
curve}
R=array of size t for i=0 to ep do
for j=0 to t do
for l=0 to k do
_q=similarityMeasure(cl,pj) if(q<_q) q=_q
_l=l bj=q.multidimensionalpolygonal curve rj=_1
C=adjustCenters(C,N,R,e) return C
end
```

Algorithm 312 as described by the foregoing pseudo-code may be expected to have a worst case run time complexity of O(T)=p*q*t*e, where the numbers of clusters into which the data curves have to be partitioned is ‘k’, ‘p’ is the number of data points in the cluster centers. ‘q’ is the number of data points in a data curve to be clustered, and ‘t’ is the total number of data curves to be clustered.

Computer trial runs to investigate cluster formation (using algorithm 312) were conducted on several consumer transaction datasets having two dimensions (e.g., Time (X-Axis), and Revenue (Y-Axis)).

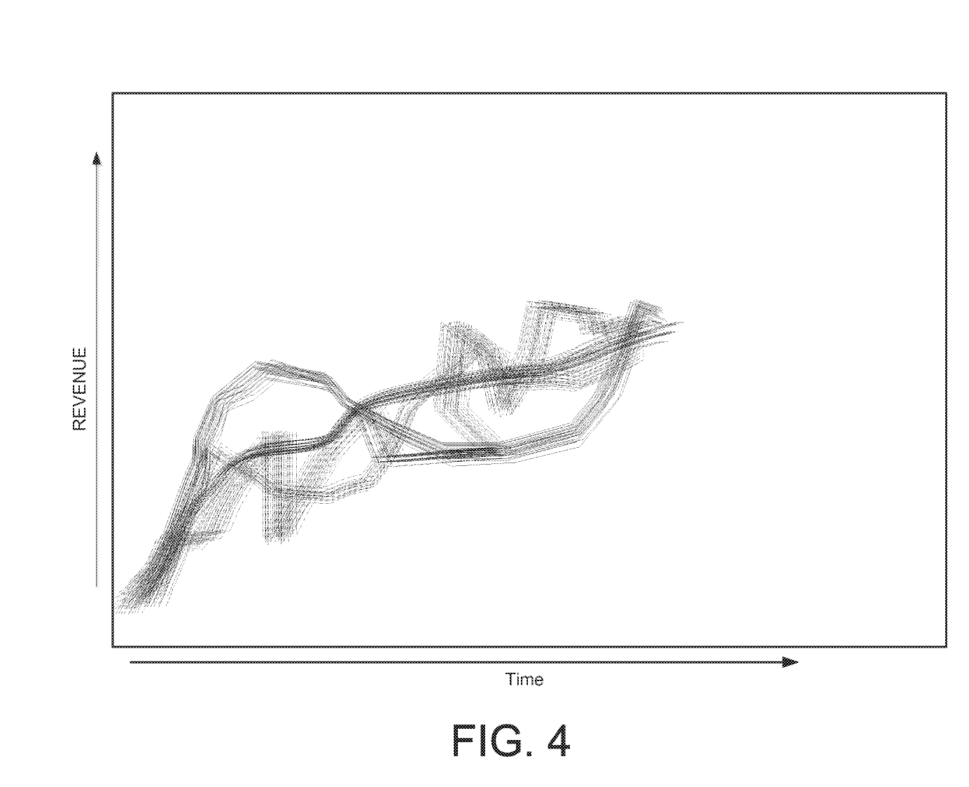

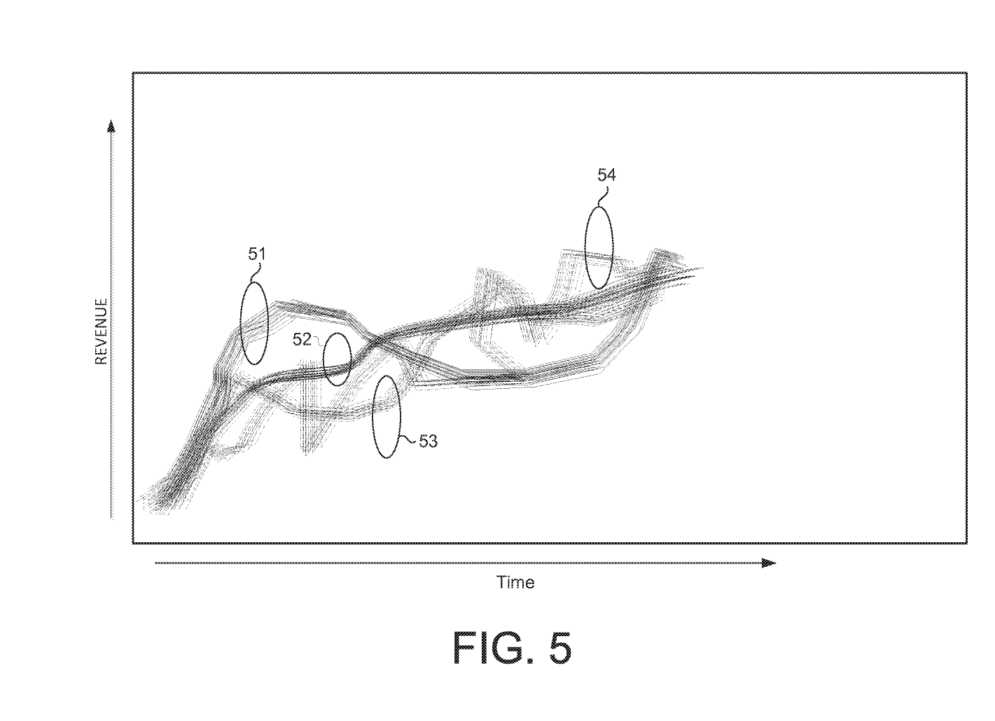

In an example set of computer trials, an example dataset included data curves for a total of 120 consumers. FIG. 4 shows a plot of the example dataset before clustering. Each line in the plot indicates data curve for a single consumer (of the total of 120 consumers). The clustering results from the set of trials in which algorithm 312 was configured to select a different numbers (e.g., 2-4) of cluster centers is shown in FIGS. 5-7.

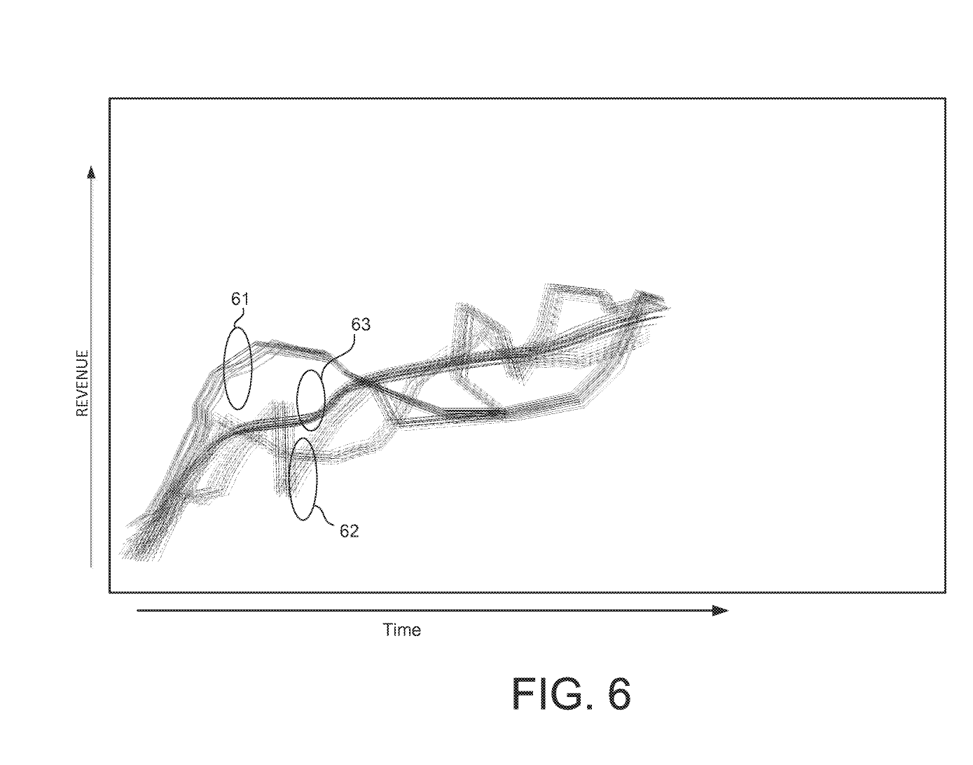

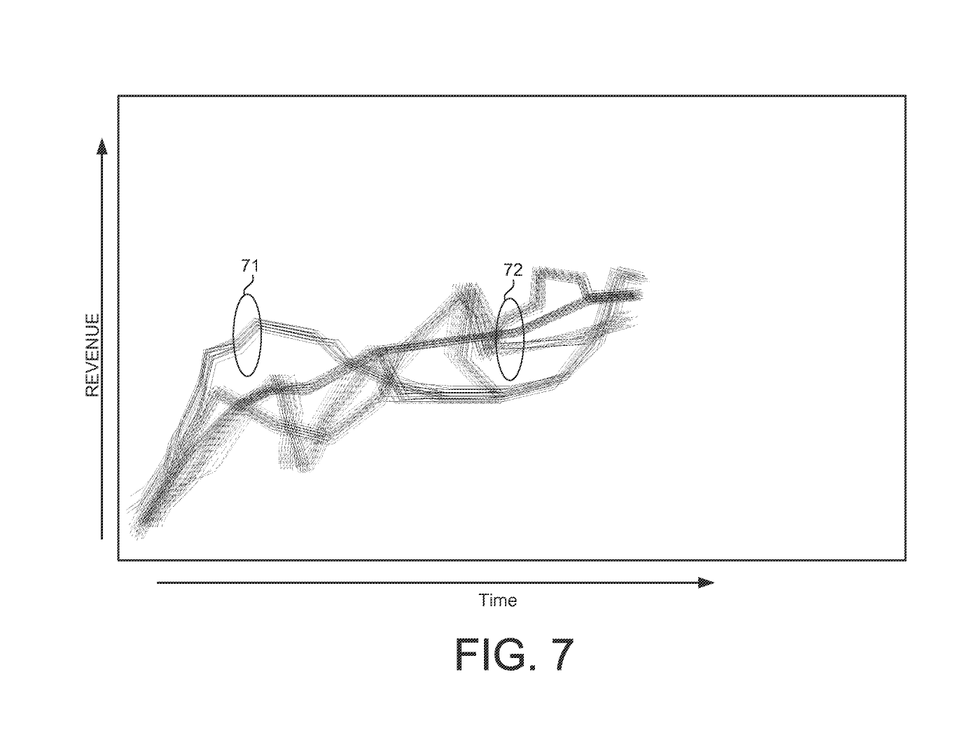

FIG. 5 shows a plot of the example dataset partitioned or grouped in to four clusters (e.g., clusters 51-54) after processing when algorithm 312 was set to select four cluster centers. FIG. 6 shows a plot of the example dataset partitioned or grouped in to three clusters (e.g., clusters 61-63) when algorithm 312 was set to select three cluster centers. FIG. 7 shows a plot of the example dataset partitioned or grouped in to two clusters (e.g., clusters 71 and 72) when algorithm 312 was set to select two cluster centers.

System 300 may use the clustering results to identify groups of consumers (or other entities associated with the clustered data records) having similar group characteristics (e.g., similar purchasing propensities or spending habits). A user of system 300 (e.g., a retailer) may then provide differentiated services (e.g., differentiated or targeted marketing, delivery of different types of products, or delivery of different types of customized services) to the different groups of consumers based, for example, on the different group characteristics.

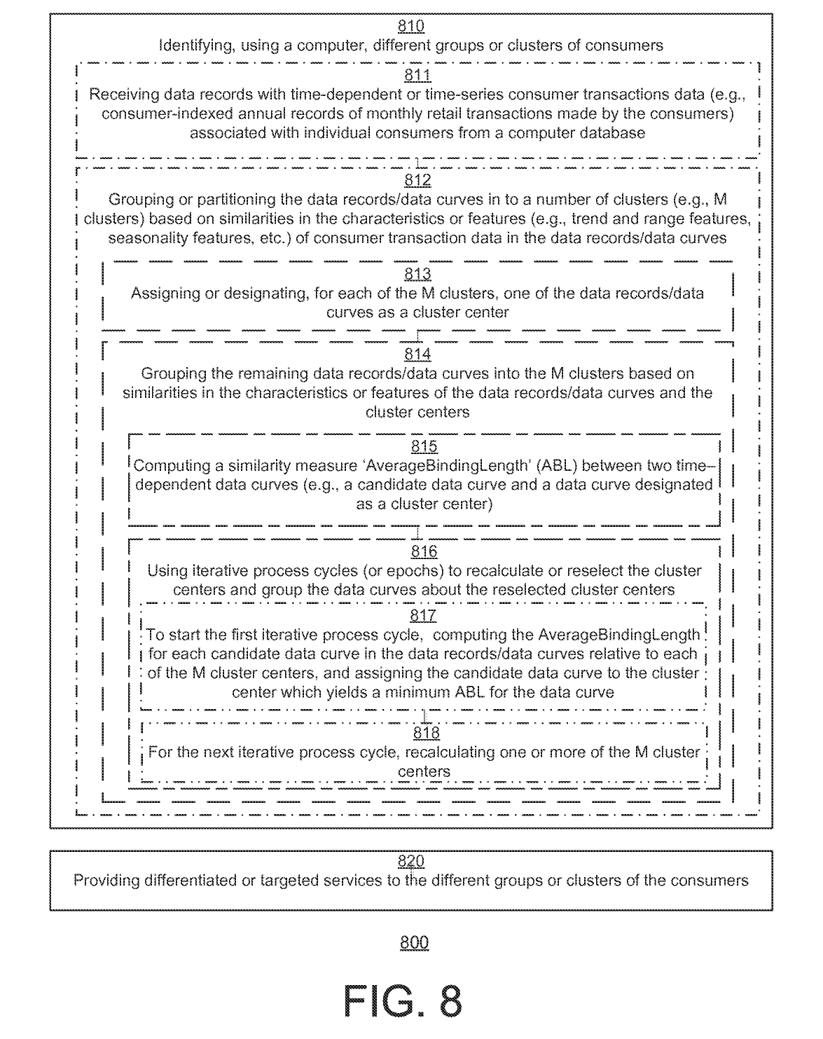

FIG. 8 shows an example method 800 for providing differentiated services (e.g., products, goods, incentives, marketing materials, customized services, etc.) to entities (e.g., consumers), in accordance with the principles of the disclosure herein.

Method 800 may include identifying, using a computer, different groups or clusters of the consumers (810) and providing differentiated or targeted services to different groups or clusters of the consumers (820). The number of different groups or clusters of the consumers may be a user-selected number or a computer-selected number (e.g., randomly selected).

In method 800, identifying, using a computer, the different groups or clusters of the consumers 810 may involve receiving data records with time-dependent or time-series consumer transactions data (e.g., e.g., consumer-indexed annual records of monthly retail transactions by the consumers) associated with individual consumers from a computer database (811). A data record may be represented equivalently by a data curve extending over a time period or range of the data record. The data record/data curve may have characteristics or features such as trend features (i.e., increasing or decreasing in time), rate features (e.g., rate-of change, slope or steepness) and seasonality features (e.g., shapes over time segments that may repeat, for example, year-to-year). Method 800 may include grouping or partitioning the data records/data curves in to a number of clusters (e.g., M clusters) based on similarities in the characteristics or features (e.g., trend-in-time and rate-of-change features, seasonality features, etc.) of the data records/data curves (812). The number of clusters M may, for example, be a user-selected number. Method 800 may involve assigning or designating, for each of the M clusters, one of the data records/data curves as a cluster center (813), and grouping or partitioning the remaining data records/data curves into the M clusters based on similarities in the characteristics or features of the data records/data curves and the respective cluster centers (814).

In an example implementation of method 800, grouping or partitioning the remaining data records/data curves in to the M clusters based on similarities in the characteristics or features of the data records/data curves and the cluster centers 814 may involve computing a similarity measure ‘AverageBindingLength’ (ABL) between two time-dependent data curves (e.g., a candidate data curve and a data curve designated as a cluster center), where the ‘BindingLength’ between the two time-dependent data curves may be defined as the ‘maximum distance between the data points minimized over all possible pairing of the data points in the two time-dependent data curves’(815).

Further, method 800 may involve by using iterative process cycles (or epochs) to recalculate or reselect the cluster centers and group the data curves about the reselected cluster centers (816).

To start the first iterative process cycle or epoch, method 800 may involve computing the AverageBindingLength (ABL) for each candidate data curve in the data records/data curves relative to each of the M cluster centers, and assigning the candidate data curve to the cluster center which yields a minimum ABL for the data curve (817).

For the next iterative process cycle or epoch, method 800 may involve recalculating one or more of the M cluster centers (818). The cluster center for a given cluster may be recalculated using the data records/data curves that were assigned to the given cluster in the previous epoch. The “new” or recalculated cluster center may be a new data curve obtained by taking a point wise average of the data records/data curves that were assigned to the given cluster in the previous epoch.

Each iterative process cycle or epoch of algorithm 312 may involve calculating new cluster centers and re-assigning the data curves in the dataset D to the new cluster center as described above.

The M clusters of data records/data curves generated by method 800 may identify M different groups or clusters of entities (e.g., consumers) associated with the data records/data curves that have correspondingly different characteristics or features (e.g., consumer needs, spending habits, etc.). The different characteristics of features of the M clusters may be used as a basis for providing services (e.g., products, goods, incentives, marketing materials, personal or customized services, etc.) that are differentiated or targeted cluster-by-cluster to the entities (e.g., consumers) in the clusters.

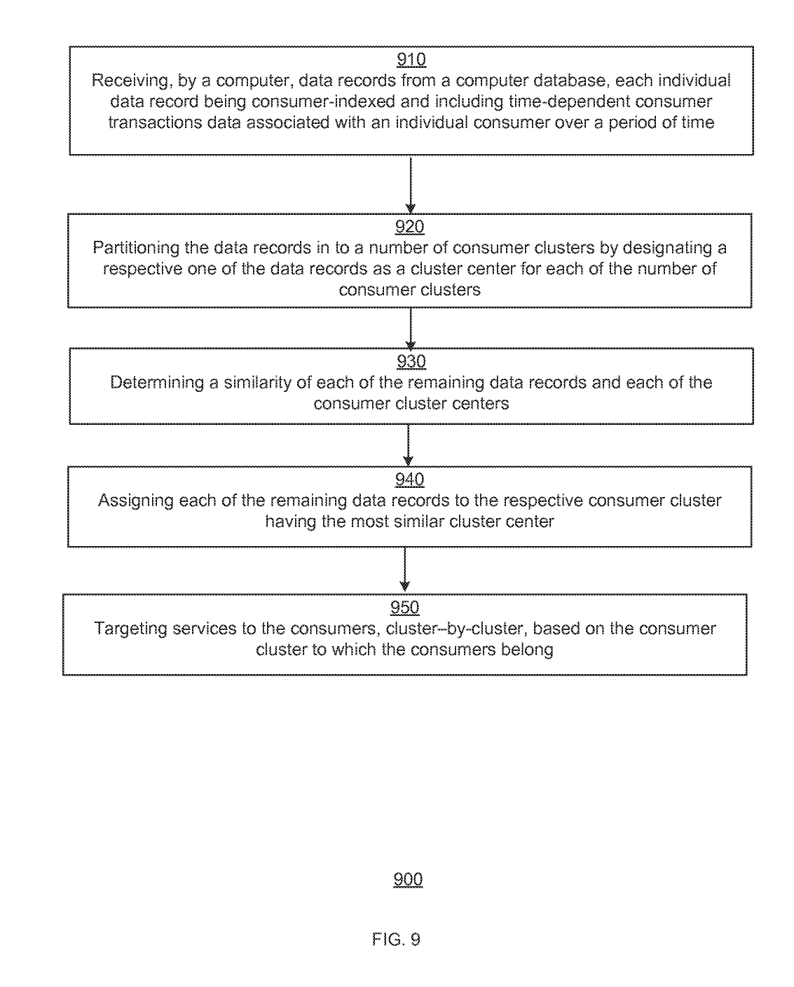

FIG. 9 shows another example method 900 for providing differentiated services (e.g., products, goods, incentives, marketing materials, customized services, etc.) to entities (e.g., consumers), in accordance with the principles of the disclosure herein.

Method 900 includes receiving, by a computer, data records from a computer database (910). Each individual data record may be consumer-indexed and include time-dependent consumer transactions data associated with an individual consumer over a period of time. Method 900 may additionally include partitioning the data records in to a number of consumer clusters by designating a respective one of the data records as a cluster center for each of the number of consumer clusters (920), determining a similarity between each of the remaining data records and each of the consumer cluster centers (930), and assigning each of the remaining data records to the respective consumer cluster having the most similar cluster center (940). Method 900 further includes providing differentiated services to the consumers or targeting services to the consumers, cluster-by-cluster, based on the consumer clusters to which the consumers belong.

Each individual data record received from the computer database may include time-dependent consumer transactions data having a trend-in-time feature and a rate-of-change feature, and/or a seasonality feature. In method 900, determining the similarity between each of the remaining data records and each of the consumer cluster centers 930 may include determining similarities of the trend-in-time features and the rate-of-change features, (and/or seasonality features) of each of the remaining data records and each of the consumer cluster centers.

Alternatively or additionally, determining a similarity of each of the remaining data records and each of the consumer cluster centers 930 may include determining an average point-to-point distance between each of the remaining data records and each of the consumer cluster centers. The cluster center at the least average point-to-point distance may be the most similar cluster center. Method 900 may further include, in iterative cycles or epochs, re-computing the designated cluster centers for each of the number of consumer clusters and re-assigning each of the remaining data records to the respective consumer cluster having the most similar recomputed cluster center. Re-computing the designated cluster centers for a given consumer cluster may include computing a point wise average of the data records assigned to the given consumer cluster in a previous iterative cycle. The iterative cycles may be stopped or exited when fewer than a pre-defined number of data records are re-assigned to a different consumer cluster in a current iterative cycle or when average point-to-point distances between the designated cluster centers and corresponding re-computed cluster centers are less than a pre-defined distance.

In method 900, targeting services to the consumers, cluster-by-cluster, based on the consumer cluster to which the consumers belong may include providing the consumers with cluster-differentiated services including one or more of products, goods, incentives, marketing materials and customized services.

The various systems and techniques described herein may be implemented in digital electronic circuitry, or in computer hardware, firmware, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method for providing services to consumers, the method comprising:
receiving, by a computer, data records from a computer database, each individual data record being consumer-indexed and including time-dependent consumer transactions data associated with an individual consumer over a period of time;
partitioning the data records in to a number of consumer clusters by designating a respective one of the data records as a cluster center for each of the number of consumer clusters,
determining a similarity between each of the remaining data records and each of the consumer cluster centers, and
assigning each of the remaining data records to a respective consumer cluster having the most similar cluster center; and
targeting services to the consumers, cluster-by-cluster, based on the consumer cluster to which the consumers belong.

2. The method of claim 1, wherein each individual data record includes time-dependent consumer transactions data having a trend-in-time feature and a rate-of-change feature, and wherein determining the similarity between each of the remaining data records and each of the consumer cluster centers includes determining similarities of the trend-in-time features and the rate-of-change features of each of the remaining data records and each of the consumer cluster centers.

3. The method of claim 1, wherein each individual data record includes time-dependent consumer transactions data having a seasonality feature, and wherein determining the similarity between each of the remaining data records and each of the consumer cluster centers includes determining similarities of the seasonality features of each of the remaining data records and each of the consumer cluster centers.

4. The method of claim 1, wherein determining a similarity between each of the remaining data records and each of the consumer cluster centers includes determining an average point-to-point distance between each of the remaining data records and each of the consumer cluster centers, and wherein the cluster center having the least average point-to-point distance is the most similar cluster center.

5. The method of claim 4, further comprising, in iterative cycles, re-computing the designated cluster centers for each of the number of consumer clusters and re-assigning each of the remaining data records to the respective consumer cluster having the most similar re-computed cluster center.

6. The method of claim 5, wherein re-computing the designated cluster center for the given consumer cluster includes computing a point wise average of the data records assigned to the given consumer cluster in a previous iterative cycle.

7. The method of claim 5, further comprising, exiting the iterative cycles when fewer than a pre-defined number of data records are re-assigned to a different consumer cluster in a current iterative cycle or when average point-to-point distances between the designated cluster centers and corresponding re-computed cluster centers are less than a pre-defined distance.

8. The method of claim 1, wherein targeting services to the consumers, cluster-by-cluster, based on the consumer cluster to which the consumers belong, includes providing the consumers with cluster-differentiated services including one or more of products, goods, incentives, marketing materials and customized services.

9. A system for providing targeted services to different groups of consumers, the system comprising a memory and a semiconductor-based processor, the memory and the processor forming one or more logic circuits configured to:
receive data records from a computer database, each individual data record being consumer-indexed and including time-dependent consumer transactions data associated with an individual consumer over a period of time;
partition the data records in to a number of consumer clusters by designating a respective one of the data records as a cluster center for each of the number of consumer clusters,
determine a similarity between each of the remaining data records and each of the consumer cluster centers, and
assign each of the remaining data records to the respective consumer cluster having the most similar cluster center; and
target services to the consumers, cluster-by-cluster, based on the consumer cluster to which the consumers belong.

10. The computer system of claim 9, wherein each individual data record includes time-dependent consumer transactions data having a trend-in-time feature and a rate-of-change feature, and wherein the logic circuits are configured to determine similarities of the trend-in-time features and the rate-of-change features of each of the remaining data records and each of the consumer cluster centers.

11. The computer system of claim 9, wherein each individual data record includes time-dependent consumer transactions data having a seasonality feature, and wherein the logic circuits are configured to determine similarities of the seasonality features between each of the remaining data records and each of the consumer cluster centers.

12. The computer system of claim 9, wherein the logic circuits are configured to determine a similarity between each of the remaining data records and each of the consumer cluster centers by determining an average point-to-point distance between each of the remaining data records and each of the consumer cluster centers, and identify the cluster center at the least average point-to-point distance as being the most similar cluster center.

13. The computer system of claim 12, wherein the logic circuits are further configured to, in iterative cycles, re-compute the designated cluster centers for each of the number of consumer clusters and re-assign each of the remaining data records to the respective consumer cluster having the most similar recomputed cluster center.

14. The computer system of claim 13, wherein the logic circuits are configured to re-compute the designated cluster center for a given consumer cluster by computing a point wise average of the data records assigned to the given consumer cluster in a previous iterative cycle.

15. The computer system of claim 13, wherein the logic circuits are further configured to exit the iterative cycles when fewer than a pre-defined number of data records are re-assigned to a different consumer cluster in a current iterative cycle or when average point-to-point distances between the designated cluster centers and corresponding re-computed cluster centers are less than a pre-defined distance.

16. The computer system of claim 9, wherein dynamic programming routines are used to partition the data records in to the number of consumer clusters.

17. A non-transitory computer readable storage medium having instructions stored thereon, including instructions which, when executed by a microprocessor, cause a computer system to:
receive data records of consumers from a computer database, each individual data record being consumer-indexed and including time-dependent consumer transactions data associated with an individual consumer over a period of time;
partition the data records in to a number of consumer clusters by designating a respective one of the data records as a cluster center for each of the number of consumer clusters,
determine a similarity between each of the remaining data records and each of the consumer cluster centers, and
assign each of the remaining data records to the respective consumer cluster having the most similar cluster center.

18. The non-transitory computer readable storage medium of claim 17, wherein instructions stored thereon include instructions which cause the computer system to determine a similarity between each of the remaining data records and each of the consumer cluster centers by determining an average point-to-point distance between each of the remaining data records and each of the consumer cluster centers, and identify the cluster center at the least average point-to-point distance as being the most similar cluster center.

19. The non-transitory computer readable storage medium of claim 18, wherein instructions stored thereon include instructions which cause the computer system to, in iterative cycles, re-compute the designated cluster centers for each of the number of consumer clusters and re-assign each of the remaining data records to the respective consumer cluster having the most similar recomputed cluster center.

20. The non-transitory computer readable storage medium of claim 19, wherein the instructions stored thereon include instructions which cause the computer system to re-compute the designated cluster center for a given consumer cluster by computing a point wise average of the data records assigned to the given consumer cluster in a previous iterative cycle.
